(19) United States
(12) Patent Application Publication
(10) Pub. No.: US 2008/0309061 A1
(43) Pub. Date: Dec. 18, 2008

(54) Vehicle seat belt utilization safety system

(76) Inventor: Walter J. Mundy, Edmond, OK (US)

Correspondence Address: WALTER J. MUNDY, 15533 SWALLOWTAIL ROAD, EDMOND, OK, 73013, US

(21) Appl. No.: 11/818,248

(22) Filed: Jun. 14, 2007

(51) Int. Cl. B60R 22/48; G06F 17/00

(52) U.S. Cl. 280/801.1; 701/45

(57) ABSTRACT

The system algorithm defines the apparatuses and methods for the operation of any vehicle that travels the streets, roads and highways that will provide a safe incentive for the operator to insure that all occupied seats have seat belts properly fastened. The system provides that improperly fastened or altered seat belt will cause the operator to experience a denial of engine start or reduction of speed to safe control speed.

### BRIEF DESCRIPTION OF THE DRAWINGS

Reference is now made to the drawing, FIG. 1A which illustrates the Microprocessor Algorithm and the apparatuses that compose the Vehicle Seat Belt Utilization System.

FIG. 1B is composed of pressure sensors located in every seat and the sensors will be connected using wire or wireless transponder chips to the Micro Processor, FIG. 1A.

FIG. 1C is composed of the Seat Belt Circuit that all vehicles that comply with Seat Belt Utilization laws have and will be connected to the Microprocessor with an additional circuit.

FIG. 1D is composed of the Warning lights display found in compliance vehicles and will be connected to the Microprocessor with an additional circuit and will be activated by the Seat Belt status by the Microprocessor.

FIG. 1E is composed of the Warning sound apparatuses found in compliance vehicles and will be connected to the Microprocessor with an additional circuit. An additional sound announcement will advise the operator that seat belt (s) are not fastened and that the system will gradually reduce the speed to a safe speed if the seat belt is not fastened.

FIG. 1F is an additional Apparatus activated by the Microprocessor indicating that all seat belts are or are not properly fastened and an additional circuit to the start switch mechanism that will deny or delay starting the vehicle until the Seat belts are all properly fastened.

FIG. 1G is an additional apparatus activated by the Microprocessor in the event that any seat belt is unfastened after the vehicle is started and is in motion and is operating at a speed in excess of minimum highway safe speed. An additional circuit and apparatus will be provided that will over ride the Cruise Control System or if the vehicle is not equipped with such, the system will override the engine accelerator to gradually reduce the vehicle to the safe minimum speed and within a safe time frame.

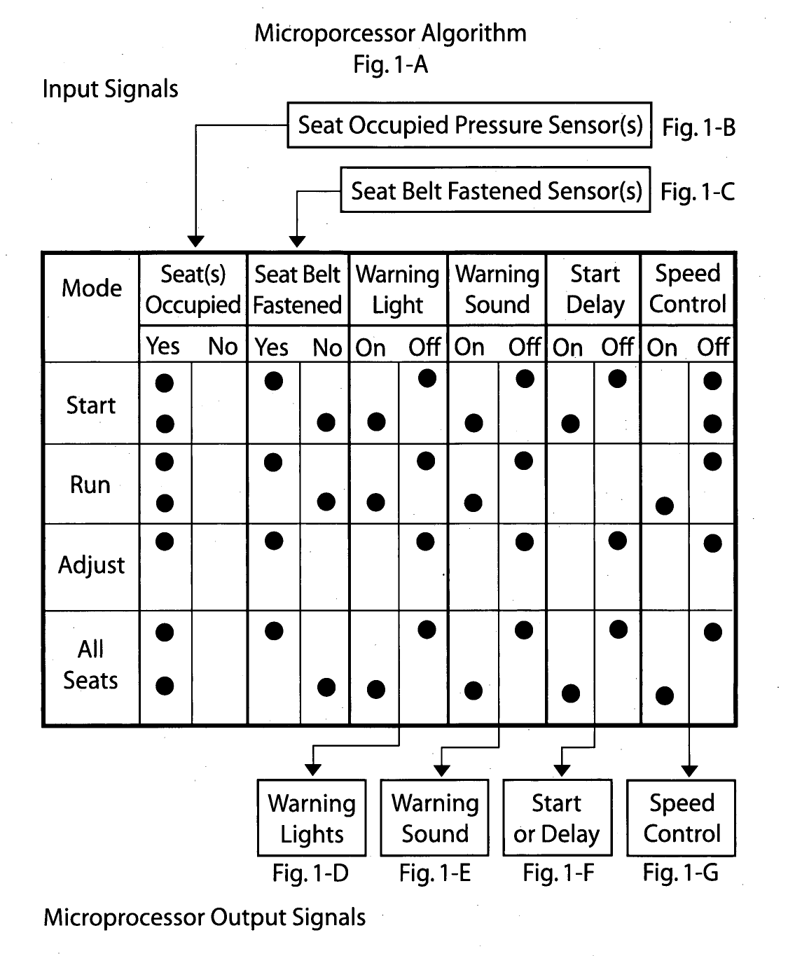

The Microprocessor Algorithm logic is illustrated in FIG. 1A and will process all of the information required to provide the operator incentive to operate the vehicle in all phases of operation, that is start, run, adjust or unfasten a seat belt during running, and corrective action to eliminate the unsafe condition. The Microprocessor proposed will be designed and or modified to accommodate the interior arrangement of the specific vehicle using both wire and micro chip wireless technology. In some vehicles, the Microprocessor could be integrated with the Vehicle's Computer.

### DESCRIPTION OF THE RELATED ART

This invention relates to Vehicle Safety and specifically to apparatus and associated connecting methods for detecting and monitoring the utilization of the vehicle seat belt(s) and provides the operator of the vehicle with the incentive to properly use the seat belt(s)

U.S. Pat. No. 6,784,803 under Description Of Related Art, provides facts and statistics concerning the cost of not using the seat belt(s) in terms of fatal injuries and in medical and law enforcement and Law Enforcement's inability to make any significant reduction in fatalities or injuries. U.S. Pat. No. 6,059,066 also provides illuminating lights on the vehicle that requires Law Enforcement to correct the lack of compliance.

The Vehicle Seat Belt Utilization System proposed places the responsibility where it belongs with the Vehicle operator by providing the operator with the ability to correct the seat belt noncompliance without incriminating his/her self.

The proposed System does not require the Automotive Industry to modify or add anything to the exterior of the vehicle and does not require any apparatuses to be installed or operated by Law Enforcement. The proposed System will provide the incentive that even die hard non seatbelt operators will learn to comply or face the options of severe but safe inconveniences. The proposed System is not a passive reminder variety that can be found in most street, road and highway vehicles manufactured in the past twenty years and or are proposed in the many patents that are using the ineffective passive logic.

1. The Vehicle Seat Belt Utilization Safety System is comprised of the apparatuses required to provide the operator of any street, road or highway vehicle with one or more seats equipped with seat belts, major incentive to comply with the use of the seat belt by providing the following;
(a) Start denial or delay.
(b) Warning display and sound.
(c) All passenger and operator seat (s) occupied identified using seat pressure sensors.
(d) Speed reduction warning and control if any seat belt is unfastened or disabled after starting.

2. The Automotive Industry has not provided any of the safety apparatuses or capabilities of the proposed system other than seat belt warning display and alarm sound, both of which are readily disarmed or ignored and do not provide the incentive to require the operator or passenger to comply.

3. The Vehicle Seat Belt Utilization Safety. System is designed to be an integrated system in new vehicles and to provide an after market system for installation in existing vehicles.

4. The apparatuses required to provide for the claim 1 (a) will require the addition of a circuit to the start switch mechanism, or push on/off button, FIG. 1F from the Microprocessor, FIG. 1. (a)

5. The Apparatuses required to provide for the claim 1.(b) will require the addition of a circuit from the Microprocessor, FIG. 1.A to warning light displays, FIG. 1D and warning alarm FIG. 1D existing in all vehicles. An additional alarm will be included to provide the operator a warning of the conditions outlined in claim 1.(d) will be initiated within a fixed time interval.

6. The Apparatuses required to provide for the claim 1.(c) will require a circuit from the Microprocessor, FIG. 1A to pressure sensors from the seat (s) FIG. 1.B.

7. The Apparatuses required to provide for the speed reduction and control as described in claim 1. (d) will require the addition of a circuit from the Microprocessor FIG. 1.A to an additional speed Control FIG. 1.G that will over ride the Cruise Control System, or engine accelerator FIG. 1.G and/or will warn the operator that the system will gradually reduce the vehicle to the minimum safe speed and within a safe time frame.

8. The location of the component parts of the Vehicle Seat Belt Utilization Safety System will integrate existing and new parts and circuits to provide the Automotive Industry with maximum flexibility in the use of existing technology and innovative design to accommodate the many makes and models of vehicles. Both wire and wireless transponder chip technology may be employed.
